(19) United States
(12) Patent Application Publication
(10) Pub. No.: US 2020/0171690 A1
(43) Pub. Date: Jun. 4, 2020

(54) Cutting Jig

(71) Applicant: Terry John West, Lexington, VA (US)

(72) Inventor: Terry John West, Lexington, VA (US)

(21) Appl. No.: 16/703,671

(22) Filed: Dec. 4, 2019

Related U.S. Application Data
(60) Provisional application No. 62/775,108, filed on Dec. 4, 2018.

(51) Int. Cl. B26B 29/06; A47J 47/00

(52) U.S. Cl. CPC B26B 29/063; A47J 47/005

(57) ABSTRACT

A cutting jig which aides in preparing and presenting food items of uniform thickness and size. The jig may have a square or rectangular shape with evenly spaced slots in the side walls. The jig may include a cutting board sized to removably fit within the interior space of the jig.

### CROSS REFERENCE TO RELATED APPLICATION

This application claims the benefit of co-pending application Ser. No. 62/775,108, filed on Dec. 4, 2018, entitled CUTTING JIG.

### FIELD

The present invention generally relates to a device for guiding a knife to facilitate cutting food items, and more particularly, to a cutting jig and board configured to guide a knife to facilitate uniform cutting of a food item such as meat, into a plurality of cubes, and facilitate serving the cut food item.

### BACKGROUND

Cutting boards for use in cutting food items are generally known in the art. Cutting boards may be made of wood, plastic, nylon or other appropriate material. Devices for cutting a food item such as bread or meat into even or uniform slices are also known in the art. When cutting certain food items, such as burnt ends, it is important that the size of each piece be uniform, especially for bar-b-que or smoking competitions. It is difficult to produce uniform pieces of burnt ends using previous hand slicing. Even if the piece of meat was perfectly uniform in shape, the human eyes and hands are not sufficiently reliable to produce an even thickness within every individual slice. A slight change in the angle of the knife from perpendicular to the meat or a slight deviation in the knife being at a right angle to the longitudinal edge of the meat will produce a considerable variance in the consistency and uniformity of the cut. Additionally, the thickness of the meat may vary considerably from piece to piece resulting in different sized cut pieces, which makes it difficult to judge the quality of one piece to the next. Furthermore, it is difficult to present or serve meat once it has been cut into pieces.

### SUMMARY

In an embodiment of a cutting jig of the present invention is presented, which takes the guesswork out of perfecting brisket burnt ends. The cutting jig aides in preparing and presenting burnt ends of uniform thickness and size. The jig may have a square or rectangular shape with evenly spaced slots in the side walls. The jig may include a cutting board sized to removably fit within the interior space of the jig.

Other advantages of this cutting jig will become apparent from the following description taken in connection with the accompanying drawings, wherein is set forth by way of illustration and example an embodiment of the present invention.

### BRIEF DESCRIPTION OF THE DRAWINGS

FIG. 1 is a perspective view of an embodiment of a cutting jig in accordance with the present invention.

FIG. 2 is a perspective view of the cutting jig of FIG. 1 showing the cutting board removed.

FIG. 3 is a top plan view of the cutting jig of FIG. 1.

FIG. 4 is a bottom plan view of the cutting jig of FIG. 1.

FIG. 5 is a side elevation view of the cutting jig of FIG. 1.

FIG. 6 is a side elevation view of the cutting jig of FIG. 1.

FIG. 7 is a perspective view of the cutting board of FIG. 2 shown being used as a template to cut a piece of meat to size.

FIG. 8 is a perspective view of the cutting board of FIG. 7 shown with the meat cut to size.

FIG. 9 is a perspective view of the cutting board and meat of FIG. 8 being placed in the cutting guide of the cutting jig.

FIG. 10 is a perspective view of the meat of FIG. 9 being cut to the proper thickness.

FIG. 11 is a perspective view of the meat and cutting board of FIG. 10 removed from the cutting guide.

FIG. 12 is a perspective view of the meat of FIG. 11 being sliced in the cutting guide.

FIG. 13 is a perspective view of the cutting board of FIG. 11 being returned to the cutting guide over the uniformly sliced meat.

FIG. 14 is a perspective view of the cutting jig of FIG. 13 inverted to present the uniformly cut meat cubes on the cutting board.

### DETAILED DESCRIPTION

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “forwardly”, “rearwardly”, “upwardly”, “downwardly”, “upper”, or “lower”, for example, all refer to a position or relationship of the item to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the cutting jig as shown in the figures herein.

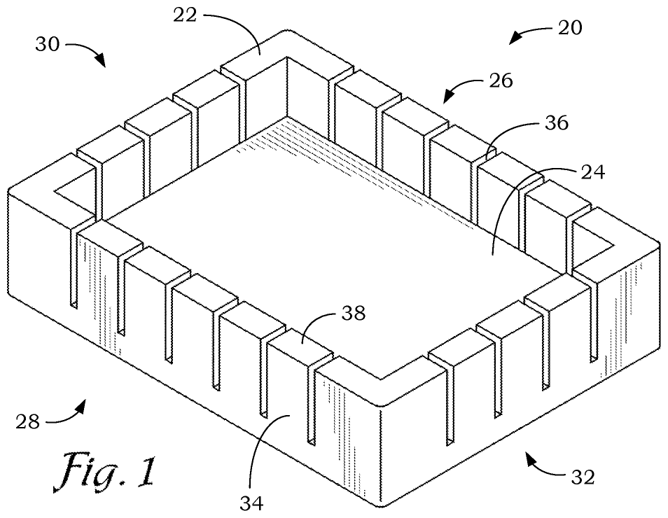

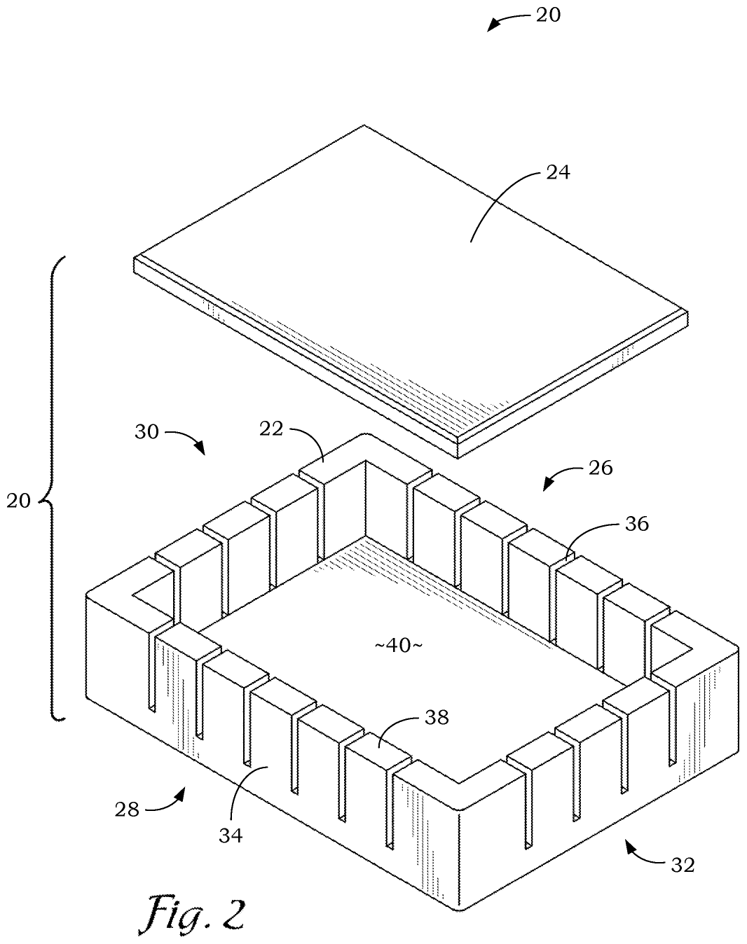

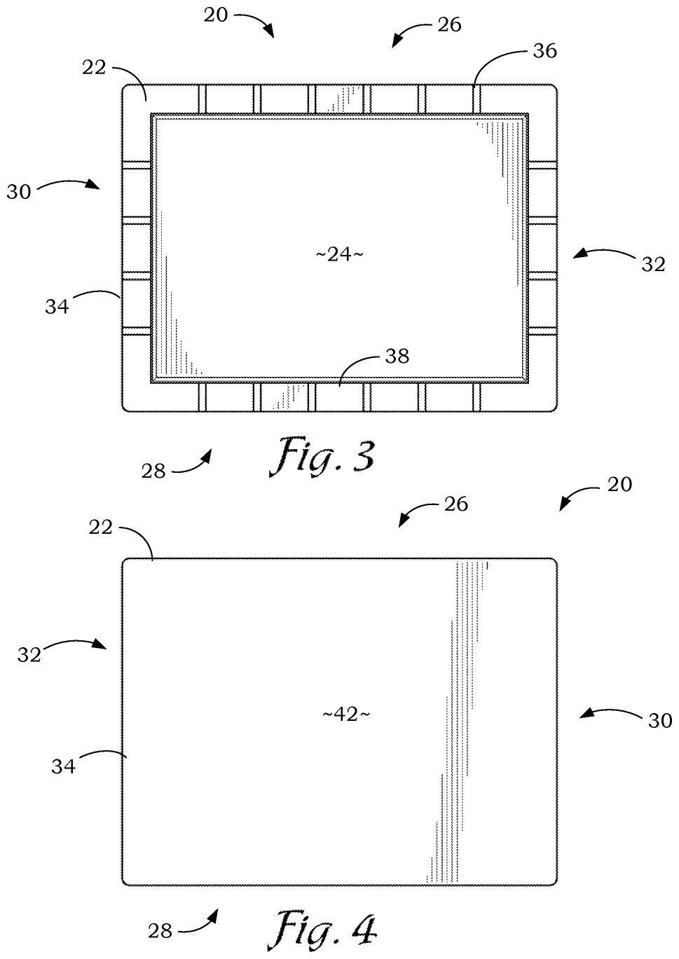

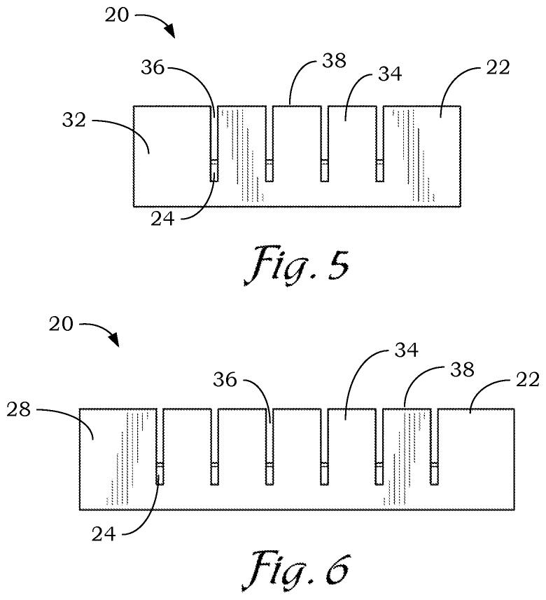

Referring initially to FIGS. 1-6, a cutting jig of the present invention is generally indicated by reference numeral 20. Cutting jig 20 includes a cutting guide 22 and a cutting board 24. Cutting guide 22 may be generally rectangular in shape with two long sides 26 and 28 and two short sides 30 and 32. Each of the sides have evenly spaced fingers or tines 34 of equal width. Each of the tines 34 are separated by a slot 36 which extends from the top 38 of the tines 34 to the base 40 of the cutting guide 22. The slots 36 are transversely and longitudinally aligned along each side of the cutting guide 22 and perpendicular to the base 40. The width of each slot 36 is sized to accommodate the blade of a knife.

The cutting board 24 may be generally rectangular in shape and sized to fit in the center area 40 of the cutting guide 22. The cutting board may be made of wood, plastic, nylon or other suitable material for a cutting board.

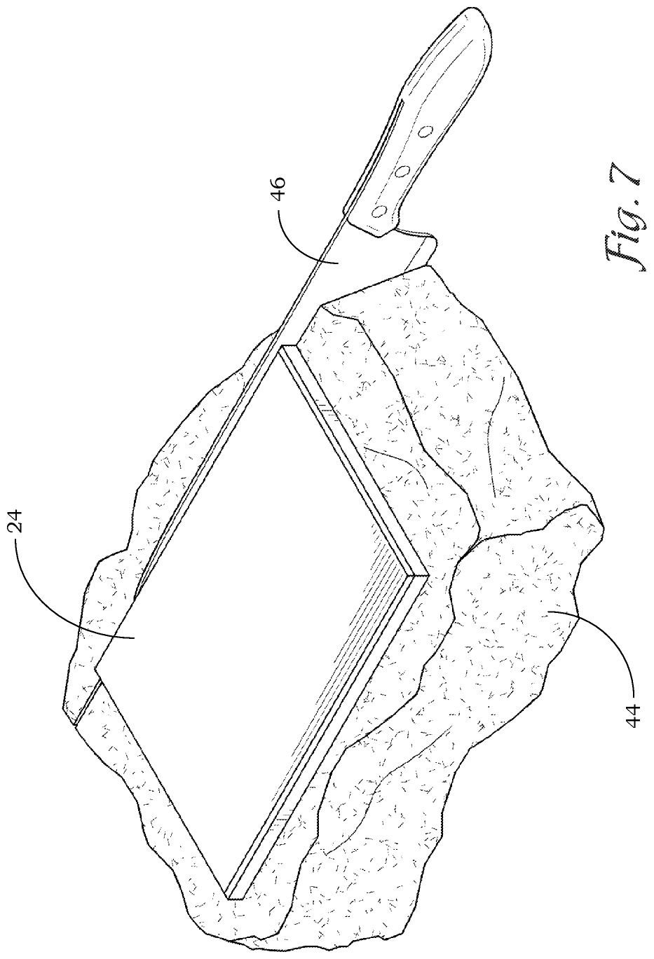

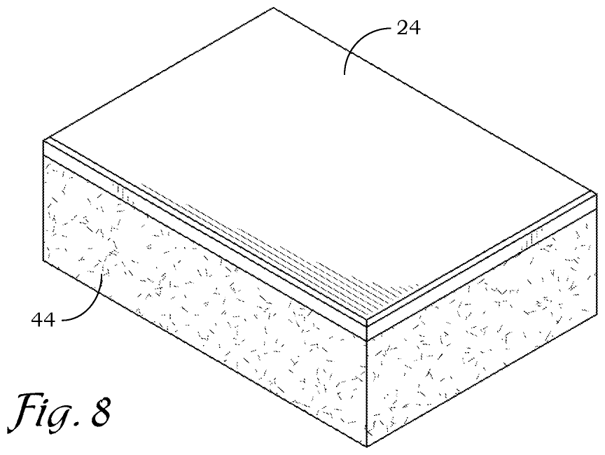

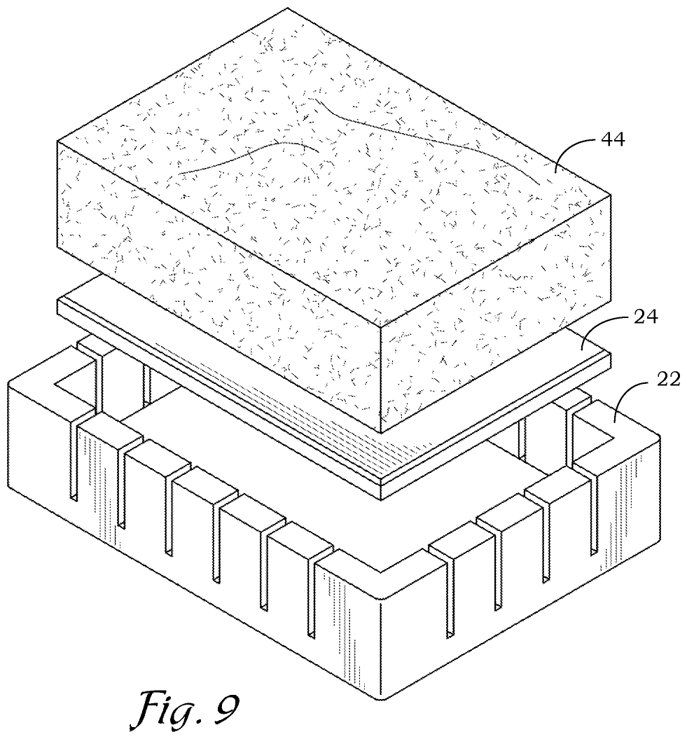

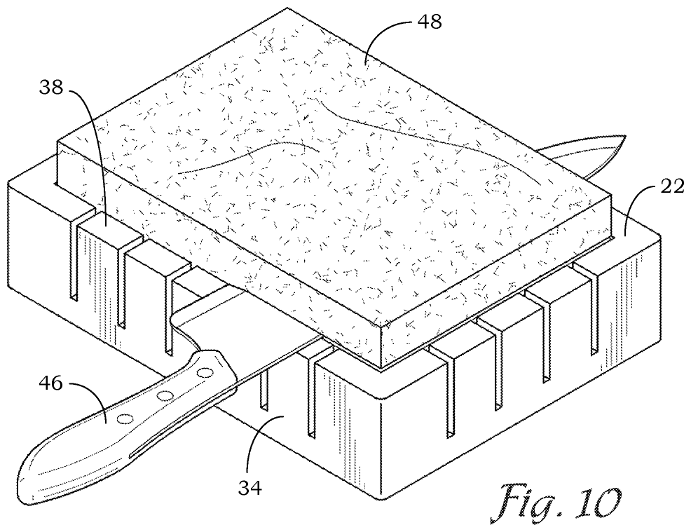

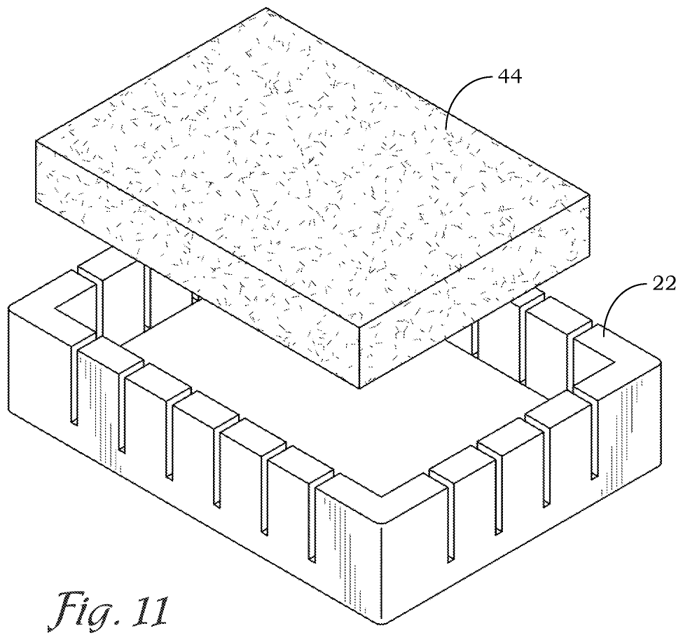

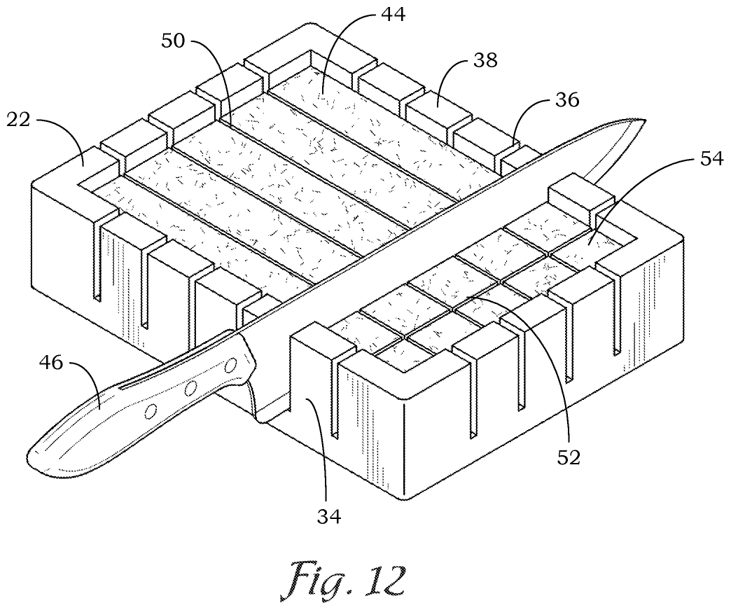

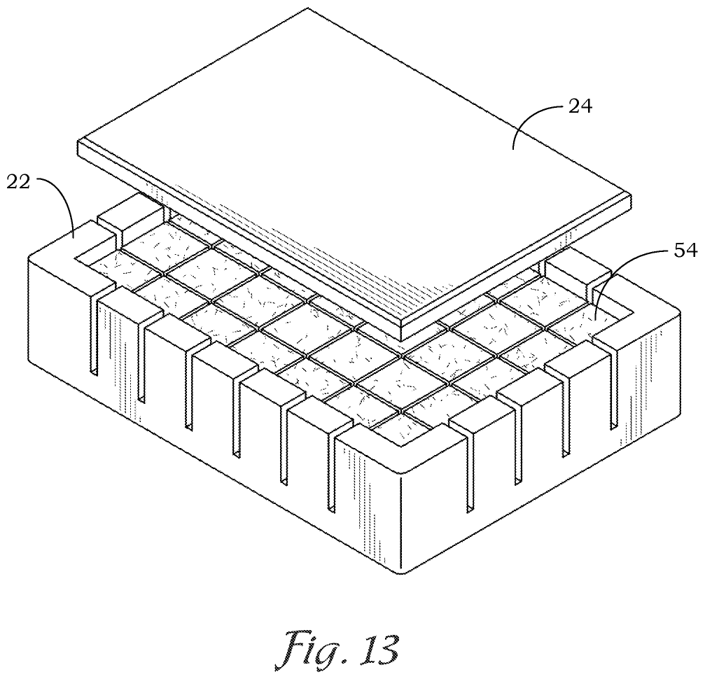

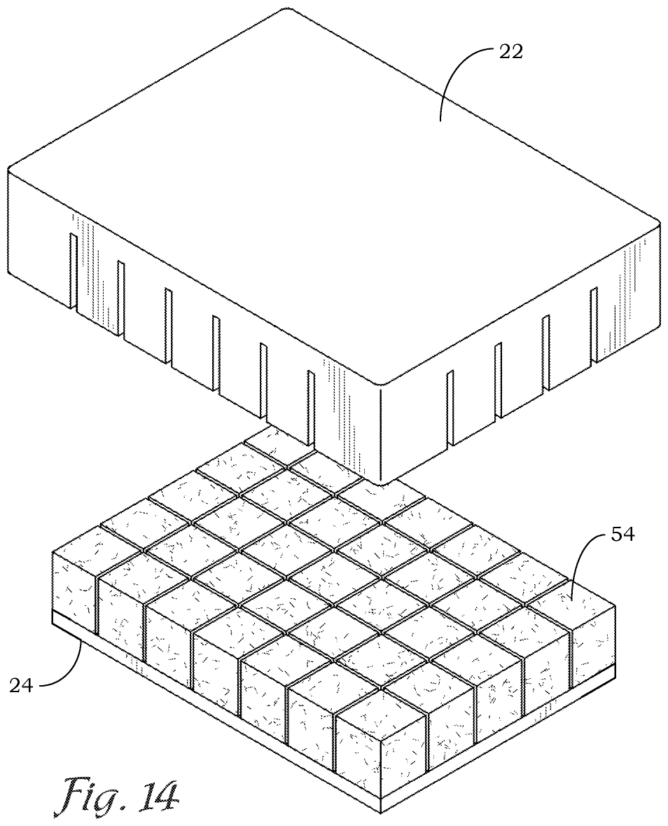

Referring to FIGS. 7-14, use of the cutting jig 20 is generally illustrated. Using the cutting board 24 as a guide, a piece of meat 44 is cut to shape. The cutting board 24 is placed on top of the meat 44, and using a knife 46, the meat 44 is cut to the shape of the cutting board 24 (see FIG. 8). The cutting board 24 is then placed in the center area 40 of the cutting guide 22 followed by the piece of meat 44 on top of the cutting board 24. A top portion 48 of the meat 44 is sliced away using the knife 46 using the top surface 38 of the tines 34 as a guide. Once the top portion 48 of the meat 44 is sliced away, the meat 44 is a uniform thickness. The meat 44 and cutting board 24 are removed from the cutting guide 22 and the meat replaced in the center area 42 of the cutting guide 22. Using the knife 46, longitudinal slices 50, and transverse slices 52 are cut into the meat 44 using the slots 36 on opposite sides 30 and 32, and 26 and 28 of the cutting guide 22, to cut the meat 44 into uniform cubes 54.

Once the meat 44 is cut into cubes 54, the cutting board 24 is placed over the cubes 54 in the center area 40 of the cutting guide 22 covering the cubes 54. The cutting jig 20 is inverted and the cutting guide 22 is lifted up to reveal the meat cubes 54 for subsequent rendering, saucing, presentation and serving.

It is to be understood that while certain now preferred forms of this invention have been illustrated and described, the present invention is not to be limited to the specific forms or arrangement of parts described and shown, and that the various features described may be combined in other ways than those specifically described without departing from the scope of the present invention.

Having thus described the invention, what is claimed as new and desired to be secured by Letters Patent is:

1. A cutting jig and board comprising:
a rectangular cutting guide having a base, four sides of equal height and a center area, each of said sides having evenly-spaced tines, each of said tines is separated by a slot extending from a top of said respective one of said four sides to said base, said slots are longitudinally and transversely aligned along each side with a respective opposite side of said rectangular cutting guide;
a rectangular cutting board sized to fit within said center area of said rectangular cutting guide;
whereby said rectangular cutting board is placed on top of a food item and the food item trimmed vertically along the perimeter of the rectangular cutting board to match the perimeter of the rectangular cutting board, presenting a shaped food item,
whereby said rectangular cutting board is placed in the center area of said rectangular cutting guide;
whereby the shaped food item is placed on the rectangular cutting board in the center area of the rectangular cutting guide and trimmed horizontally along the top of the sides of the rectangular cutting guide to present a trimmed food item of a uniform thickness;
whereby the trimmed food item and rectangular cutting board are removed from the center area of the rectangular cutting guide;
whereby the trimmed food item is placed in the center area of the rectangular cutting guide and the trimmed food item is cut vertically along longitudinally and transversely aligned slots in said sides;
whereby said rectangular cutting board is placed over the trimmed food item, said rectangular cutting guide is inverted and placed with said rectangular cutting board down, and said rectangular cutting guide lifted presenting a plurality of uniformly cut food items.

2. A cutting jig and board comprising:
a rectangular cutting guide having a base, four sides of equal height and a center area, each of said sides having evenly-spaced tines, each of said tines is separated by a slot extending from a top of said respective one of said four sides to said base, said slots are longitudinally and transversely aligned along each side with a respective opposite side of said rectangular cutting guide;
a rectangular cutting board sized to fit within said center area of said rectangular cutting guide;
whereas when said rectangular cutting board is placed in said center area of said rectangular cutting guide, the distance from a top surface of said tines is equal to the width of said tines;
whereby said rectangular cutting board is placed on top of a food item and the food item trimmed vertically along the perimeter of the rectangular cutting board to match the perimeter of the rectangular cutting board, presenting a shaped food item,
whereby said rectangular cutting board is placed in the center area of said rectangular cutting guide;
whereby the shaped food item is placed on the rectangular cutting board in the center area of the rectangular cutting guide and trimmed horizontally along the top of the sides of the rectangular cutting guide to present a trimmed food item of a uniform thickness;
whereby the trimmed food item and rectangular cutting board are removed from the center area of the rectangular cutting guide;
whereby the trimmed food item is placed in the center area of the rectangular cutting guide and the trimmed food item is cut vertically along longitudinally and transversely aligned slots in said sides;
whereby said rectangular cutting board is placed over the trimmed food item, said rectangular cutting guide is inverted and placed with said rectangular cutting board down, and said rectangular cutting guide lifted presenting a plurality of uniformly cut cubes of the food items.
